(19) United States
(12) Patent Application Publication
(10) Pub. No.: US 2003/0182166 A1
(43) Pub. Date: Sep. 25, 2003

(54) Entrepreneurship evaluation methods and systems

(76) Inventor: A. David Silver, Santa Fe, NM (US)

Correspondence Address: KERMIT D. LOPEZ / LUIS M. ORTIZ, ORTIZ & LOPEZ, PLLC PATENT ATTORNEYS, P.O.BOX 4484, ALBUQUERQUE, NM, 87196-4484, US

(21) Appl. No.: 10/102,106

(22) Filed: Mar. 19, 2002

(51) Int. Cl. G06F 17/60

(52) U.S. Cl. 705/7

(57) ABSTRACT

Methods, systems and computer program products for evaluating the probability of success or failure of an entrepreneurial endeavor. A plurality of entrepreneurial issues associated with the entrepreneurial endeavor are generally designated, such that a value is assigned from among a plurality of values to each entrepreneurial issue. A score than be compiled based on a summation of the values respectively assigned the entrepreneurial issues, such that the compiled score is indicative of the probability of success or failure of the entrepreneurial endeavor.

### TECHNICAL FIELD

The present invention is related in general to financial evaluation methods and systems. The present invention is also related to methods and systems for enhancing entrepreneurial success. The present invention is generally related to methods and systems for evaluating the success or failure of an entrepreneurial endeavor. The present invention is also related to computer program products, which may be implemented via data-processing systems and computer and telecommunications networks thereof.

### BACKGROUND OF THE INVENTION

Venture capital, generally, refers to the business of financing new business undertakings, usually high risk, in the hopes of reaping big rewards if the new business is successful. In a typical scenario, an inventor, entrepreneur, businessman, or other individual or group with a new idea will ask a venture capitalist to give them money to start a business built around the new idea. As utilized herein, the term “entrepreneur” broadly refers to anyone seeking venture capital. A venture capitalist (VC) can be an individual, partnership, corporation, or any other group with excess capital that is willing to invest in a high-risk business venture. The financial return for the venture capitalist may be large, or the investment could be a total loss.

The present inventor believes that it is possible to closely predict in advance of the launch of a new company the probability of its success or failure, along with how much capital it will require and the probable rate of return on that capital. The present inventor also believes that entrepreneurship is a science rather than a game or an art, and that a certain outcome can be quantified once accurate values are assigned for their inputs. If the success or failure of a business venture can be determined with high probability in advance, then it holds that only a certain minimum amount of risk capital is required by an economy, that capital invested above that amount will be wasted, and that capital can be supplied primarily to the entrepreneurial companies that exhibit the highest probability of success with more productivity and employment per dollar invested. Productivity, employment, problem-solving and wealth creation can be more predictable by determining the success or failure of a business in advance.

Based on the foregoing, the present inventor believes that a need exists for methods and systems for accurately predicting in advance the success or failure of a new company, along with the rate or return, or potential loss on an investment in an entrepreneurial venture. Entrepreneurship has never been mathematically modeled and implemented within the context of an interactive method and system, including computer program products thereof. In fact, up until now it has been studied by observers and practitioners, but principally on an anecdotal basis. Such a method and system could assist a community, state, or city in predicting which types of industries have the greatest probability of succeeding and the least amount of capital in their region, and thereby maximize the capital that they deploy. Such a method and system could also be of vital importance to emerging countries and developing regions thereof seeking to lift their economies, while providing exciting opportunities to their creative young, thus halting “brain drain” away from their communities and creating opportunities for employment and productivity. Venture capital that is wasted on companies that should probably never have been started or funded in the first place can now be preserved. That capital can instead be deployed elsewhere and enjoy higher returns.

The intended use of such predictability methods and systems includes the would-be or early-stage entrepreneur who is about to, or has just begun to, take the plunge and launch his or her new business. By processing his or her business model through an analysis using mathematical models, the entrepreneur will know with a higher degree of certainty if the new business will succeed or fail, how much capital it might consume and a projected return on that capital.

### BRIEF SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

It is therefore one aspect of the present invention to provide methods, systems and computer program products for evaluating the success or failure of an entrepreneurial endeavor.

It is also another aspect of the present invention to provide methods, systems and computer program products for scoring the success or failure of an entrepreneurial endeavor based on a plurality of entrepreneurial factors.

The above and other aspects can be achieved as is now described. Methods and systems, including a computer programs product thereof, are disclosed herein for evaluating the probability of success or failure of an entrepreneurial endeavor. A plurality of entrepreneurial issues associated with the entrepreneurial endeavor are generally designated, such that a value can be assigned from among a plurality of values to each entrepreneurial issue. A score can then be compiled based on a summation of the values respectively assigned the entrepreneurial issues, such that the compiled score is indicative of the probability of success or failure of the entrepreneurial endeavor.

The entrepreneurial issues to be evaluated include factors represented by variables P, S and E, wherein S represents an elegance of an entrepreneurial solution and E represents an experience of an associated entrepreneurial team. A valuation of the entrepreneurial endeavor can be determined based on a formulation V=P×S×E, wherein V represents the valuation, S represents the elegance of the entrepreneurial solution and E represents the experience of the associated entrepreneurial team.

A value may be assigned to P, wherein the value comprises a number 1, a number 2 or a number 3, such that the number 1 is associated with a large-sized entrepreneurial problem, the number 2 is associated with a medium-sized entrepreneurial problem and the number 3 is associated with a small-sized entrepreneurial problem.

A value may also be assigned to S, wherein the value comprises a number 1, a number 2 or a number 3, wherein number 1 is associated with a first-to-market entrepreneurial solution, the number 2 is associated with a first-to-market and a difficult-to-replicate entrepreneurial solution, and the number 3 is associated with a proprietary, a first-to-market, and a difficult-to-replicate entrepreneurial solution.

Additionally, a value can be assigned to E, wherein the value comprises a number 1, a number 2, or a number 3, wherein the number 1 is associated with an entrepreneurial team that does not possess any prior entrepreneurial launch experience, the number 2 is associated with an entrepreneurial team possessing at least one individual who has launched and operated an entrepreneurial effort previously, and the number 3 is associated with an entrepreneurial team that has previously managed an entrepreneurial launch.

The entrepreneurial issues of concern also can include a plurality of Demonstrable Economic Justification (DEJ) factors, which are described in greater detail herein. A value may be assigned from among the plurality of values to each DEJ factor. Additionally, the plurality of entrepreneurial issues can include factors represented by variables F, M, and C, wherein F represents a “Float” factor, M represents a “Many” factor, and C represents a “Clubs” factor. The terms Float, Many and Clubs are discussed in greater detail herein.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a high-level flow chart of operations illustrating operational steps of an entrepreneurial scoring method in accordance with a preferred embodiment of the present invention;

FIG. 2 illustrates a high-level flow of operations illustrating continued operational of steps of an entrepreneurial scoring method in accordance with a preferred embodiment of the present invention;

FIG. 3 depicts a prior art graph illustrating the five stages of a start-up company;

FIG. 4 illustrates a prior art graph indicating target rates of return of a typical venture capital fund;

FIG. 5 depicts a pictorial diagram of a data-processing system in which a preferred embodiment of the present invention may be implemented;

FIG. 6 illustrates a block diagram of the components for the data-processing system depicted in FIG. 5; and

FIG. 7 illustrates a client-server based system in which an embodiment of the present invention may be implemented.

### DETAILED DESCRIPTION OF THE INVENTION

The particular values and configurations discussed in these non-limiting examples can be varied and are cited merely to illustrate an embodiment of the present invention and are not intended to limit the scope of the invention.

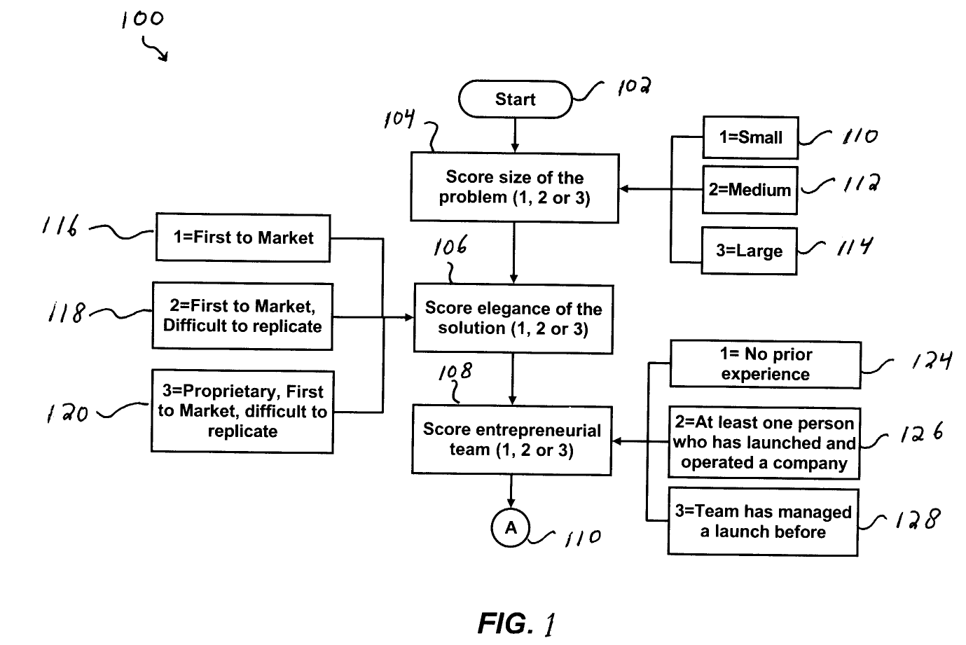

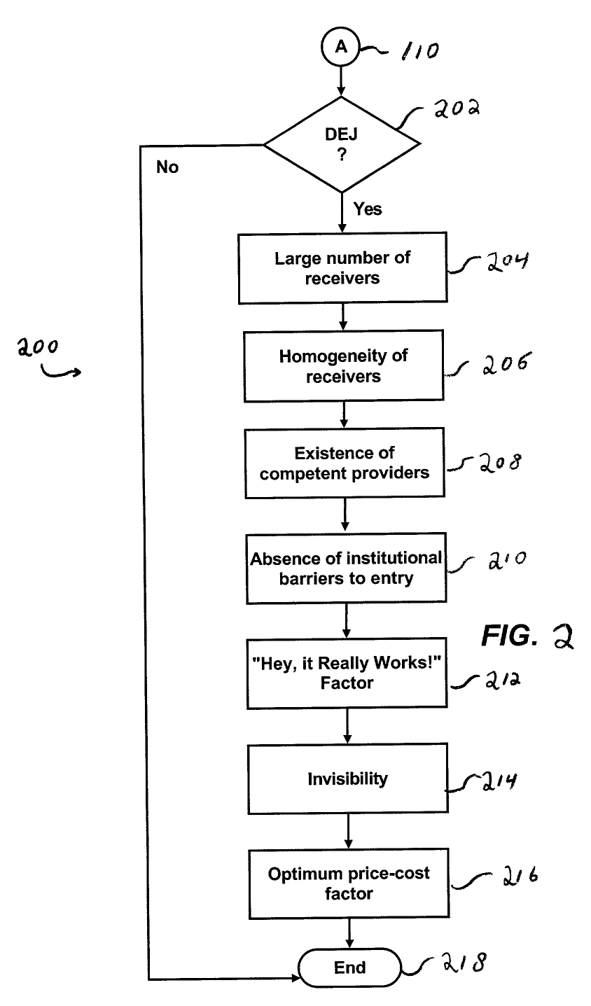

FIG. 1 depicts a high-level flow chart 100 of operations for an entrepreneurial scoring method, which may be implemented in accordance with a preferred embodiment of the present invention. Utilizing the scoring methodology illustrated in FIGS. 1 and 2 herein, an entrepreneur or venture capitalist or other interested party can determine with high probability if a new business venture or product line is worth the time, effort and capital to launch or if such efforts should simply be terminated. The process is thus initiated as indicated at block 102, and thereafter as illustrated at block 104, a score is determined indicative of the “size of the entrepreneurial problem.”

As illustrated respectively at blocks 110, 112, and 114, three values can be provided and assigned to score the size of the entrepreneurial problem, as illustrated at block 104. If the entrepreneurial problem is small, as indicated at block 110, a “1” value is assigned. An example of a “small” entrepreneurial problem is one that falls under $250 million. As illustrated at block 112, if the entrepreneurial problem is of a medium nature, a value of “2” can be assigned. An example of a “medium” entrepreneurial problem is one that falls within a range of $250 million to $900 million. As depicted at block 114, if the entrepreneurial problem is “large,” a value of “3” can be assigned. An example of a “large” entrepreneurial problem is one that falls in a range of $1 billion or more.

The size of a problem, P, can be measured by multiplying the number of people who have the problem times the price would pay for a solution. For example, 240,000 women are diagnosed each year in the United States with breast cancer. Presently, 2.1 million women have breast cancer. Assuming that each woman would pay $10,000 to solve their problem, the size of the problem is based on a calculation of 2,340,000×$10,000 or $23.4 billion. This is a very large P factor.

Next, as illustrated at block 106, “score elegance of the solution,” the proposed solution to the problem is scored, again based on a 1, 2 or 3 value-basis, as respectively indicated at block 116, 118 and 120. Thus, as depicted at block 116, a “1” value is assigned to the elegance of the entrepreneurial solution if it falls under a “first to market” category. As illustrated at block 318, a “2” value is assigned to the score the elegance of the entrepreneurial solution if it falls under a category that is first to market and also difficult to replicate. Finally, as indicated at block 120, a value of “3” is assigned to score the elegance of the entrepreneurial solution if is proprietary, first to market, and also difficult to replicate. Thus, a value of “3” is a strong rating, while a value of “1” indicates a weaker rating.

Thereafter, as depicted at block 108, “score entrepreneurial team,” the strength of the entrepreneurial team is scored based again on a 1, 2 o 3 value-basis, as indicated respectively at block 124, 126, and 128. If the entrepreneurial does not have any launch experience, then a “1” value is assigned to rate the experience of the entrepreneurial team, as illustrated at block 124. If the entrepreneurial team has at least one person has launched and operated a company before, then as depicted at block 326, a value of “2” is assigned to rate the experience of the entrepreneurial team, as indicated at block 128. The process then continues, as illustrated at continuation block 110, which is further depicted in FIG. 2.

FIG. 2 illustrates a high-level flow chart 200 of operations illustrating continued operational steps of an entrepreneurial scoring method in accordance with a preferred embodiment of the present invention. Note that in FIGS. 1 and 2, like parts or elements are indicated by identical reference numerals. Thus, following processing of the operation described at continuation block 110, a test can be performed to determine whether or not to analyze the entrepreneurial venture utilizing a plurality of DEJ (Demonstrable Economic Justification) factors.

As illustrated at block 202, a test can be processed to indicate whether or not to implement subsequent DEJ factors. If it is determined to skip the DEJ factor test, then the process simply terminates, as indicated at block 218. If it is determined to process the DEJ factors, then as illustrated thereafter at block 204, the existence of a large number of receivers is determined. The operation described at block 204 is based on the number of potential customers (i.e., “receivers”) for the entrepreneurial solution at issue, and the knowledge that such potential customers may or may not have about such an entrepreneurial solution. Next, as indicated at block 206, the homogeneity of the receivers must be determined based on whether or not the customers of the solution will accept a standard product or service, or whether or not the entrepreneurial venture at issue will have to customize the solution.

Thereafter, as illustrated at block 208, an operation is performed to determine if the solution delivery system requires, for example, expensive sales persons and a long cycle from presentation to the sale, or if merely competent sales persons are adequate to quickly make a particular sale. Thus, the operation depicted at block 408 is directed toward determining the existence of competent providers (e.g., sales, distribution, manufacturing, etc.).

Next, as indicated at block 210, an operation is performed to determine if there exists an absence/existence of institutional barriers to entry. The operation described at block 410 thus can determine if there is a restriction that must be removed before the product or service can be introduced to the market. An example of such a case may involve, for example, the necessity of a government or institutional approval process such as that of the United States Food & Drug Administration in approving new drugs and medical devices prior to their sale in the United States. Another well-known barrier to entry comes in the form of blocking intellectual property rights. For example, one or more issued patents that address the problem may belong to third parties (e.g., competitors) and can result in future patent infringement litigation and/or the payment of royalties, thus adding to the overall cost of delivering a product or service to the marketplace. Identifying the existence or absence of proprietary and/or potentially patentable subject matter (intellectual property or “IP”) that can be owned by the business venture, and which addresses the problem, is sometimes overlooked in the analysis of a business venture. In the case of a technology firm, the absence of a patent portfolio as a “barrier to entry” in front of competitors whom may also seek to compete in the marketplace by using a similar solution to address the problem can also draw a negative score.

Thereafter, as depicted at block 212, an operation can be performed to determiner if marketing of the product or service will require advertising on a grand scale, or if the benefits of the product or service can simply be passed along by word of mouth. The operation illustrated at block 212 can thus be referred to as the “Hey, it Really Works!” factor. Another means of ascertaining if product or service really works can include the need for prototyping, beta testing and/or test marketing a product or service.

Next, as indicated at block 214, an operation can be performed to determine invisibility. The operation described at block 214 can determine, for example, if the new company and its products or services can be constructed quietly, or if news will tend to leak out, thereby giving competitors an accidental or an intentional advantage. Such a news leak may give competitors a time to market advantage, especially where the competitive company is a large, publicly held and resourceful. The business venture, therefore, stands to be scored lower where there is a chance its time-to-market advantage cannot be preserved.

Finally, as depicted at block 216 an operation can be performed to determine an optimum price-cost factor. For example, does the product or service have a relatively high gross profit margin (e.g., about 80%) and considerable cash flow to deploy toward marketing and/or additional product or intellectual property development? The process can then terminate as illustrated at block 218.

Table 1 below illustrates the fact that a new company can achieve a maximum score of 45. As an analysis is performed about the new company that is planned to be launched, key components of the entrepreneurial endeavor can be held up to the mirror scoring system depicted in Table 1 presents. A perfect score of 45 means an extremely high probability of success, no or very little reliance on venture capital, and a valuation in five years approaching $500 million, and in 10 years exceeding $1 billion.

The first and most critical test is the First Law of Entrepreneurship, which is described in greater detail herein, and which indicates that valuation, V, or wealth is equal to the size of the problem (P) that has been identified, multiplied by the elegance of the solution (S) that will be sold to those who have the problem, and further multiplied by the experience of the entrepreneurial team (E). Because three factors are multiplied rather than added, a zero or negative value for either P, S, or E wipes out the company from the beginning. P, S and E have four possible values. The value 3 is the highest. The value 2 is mid-level. The value 1 is low, and the value 0 represents the absence of value.

If the new company, for example, scores 3×3×3, then that company is off to the best start possible. An entrepreneurial team that scores a 3 is likely to direct itself to a problem that also scores a 3. It has a high probability of success with a problem with a score of 2, but it will likely grow bored and break-up if it attempts to solve a problem that scores only a 1. A solution that scores a 3 has the three most important factors of any new business going for it: defense against possible competitors, uniqueness, or non-replicability (e.g., IP protection), and a head start (e.g., market lead) in the race. Whether or not the size of the problem or the experience of the entrepreneurial team score 3's, a solution that scores a 3 can always be sold to a buyer, whether or not it achieves the stage of commercial success. An S factor of 3 defines the purpose of a new business, which is to make the product or service a substitute for all other competitive products or services and to make such competitive products or services no substitute for those provided by the new business.

TABLE 1
SCORING SYSTEM

| | | | Max. | |
|---|---|---|---|---|
| | Factor | Description | Point Value | Quotient |
| 1. | P | Size of the Problem | 3 | 3 |
| 2. | S | Elegance of Solution | 3 | 9 |
| 3. | E | Entrepreneurial Team | 3 | 27 |
| 4. | DEJ #1 | Qualified Buyers | 1 | 28 |
| 5. | DEJ #2 | Competent Sellers | 1 | 29 |
| 6. | DEJ #3 | Homogeneity of Buyers | 1 | 30 |
| 7. | DEJ #4 | Large No. of Buyers | 1 | 31 |
| 8. | DEJ #5 | Existence/Lack of Barriers | 1 | 32 |
| | | to Entry | | |
| 9. | DEJ #6 | “Hey, it really works!” | 1 | 33 |
| 10. | DEJ #7 | Optimum Cost/Price | 1 | 34 |
| | | Relationship | | |
| 11. | DEJ #8 | Invisibility of the New Company | 1 | 35 |
| 12. | F | Float (multiplying 2 by DEJ | | 6 |
| | | #1, #3, and/or #4) | | |
| 13 | M | Many | | 2 |
| 14 | C | Clubs | | 2 |
| | Total | | | 45 |

The entrepreneurial scoring method and system described herein can be implemented based on a function of multiplying the values of the three factors in of the First Law of Entrepreneurship, which will be described in greater detail herein, and adding the quotient thus derived to the sum of the DEJ Factors. For instance, if the quotient is 3×2×2, or 12 and the new company has 7 of the eight DEJ Factors, the resulting entrepreneurial score is 12+7 or 19, a moderately high score.

Deploying a variety of strategies, which are discussed in greater detail herein, can boost the probability of success of a new business. Increasing the amount of float raised from customers and vendors can minimize the amount of venture capital needed. Float can achieve a value of 6. The factor Many is worth 2 points and Clubs is worth 2 points according to the entrepreneurial scoring method and system described herein.

The term “Float” is a favorite entrepreneurs. Float essentially means using the customers' payment temporarily before delivering the product or service. Most businesses launched by women, for example, rely on float, because women have not been favored with venture capital, and thus have ineluctably asked their customers to pay up-front. Vendors who are willing to wait 120 days to be paid also provide float. There are many methods to expand the sources of float in order to minimize reliance on venture capital and increase the probability of success. Ray Kroc, builder of McDonald's, for example, was a master of float, which he codified as franchising and obviated his need for venture capital.

The term Many means that there are numerous channels through which to generate revenues for the new company's product or service, but such opportunities must be explored. The opportunities that provide cash up-front are the ones that should be seized immediately. There are certain types of solution delivery methods, or business models that expand the market with each sale the new company makes, and there are others that shrink the market with each sale the company makes. Most new companies are launched with the “shrink-the-market” business model. Such companies can be converted, however, to the “expand-the-market” business model from the outset by opening five, ten or twenty additional channels up-front. Licensing large, related companies to market the product or service in foreign or selected vertical markets is one method of achieving the “expand-the-market” business approach. Launching a users group and having customers join the users group and pay a users group fee is another means for achieving such an approach. There are dozens of strategies for opening new cash flow channels, and with each channel that is opened, the probability of success of the new company can increase, along with a reduction of the its reliance on venture capital.

Clubs are another means of raising the prospect of reward by lowering the risk. Many entrepreneurs miss the opportunity to ask their customers to join in the celebration of the new solution to their problem. Yet, customers are interested in joining with others because they have questions to ask of other customers and they have ideas for improving the product or service that they would like to share with your company and with other customers. A club must offer benefits and these benefits are best delivered through company magazines, or through trade shows, which are living magazines. Clubs can generate up to 24 additional cash flow channels for the new company including subscriptions, advertisements, classifieds, endorsement fees, sponsorship fees and many more. For the entrepreneur who adds clubs to his or her business model, multiple revenue channels bring in cash every day and night of the week while the employees are sleeping, much of it at very high gross profit margins, thus enhancing the company's probability of success while minimizing its reliance on venture capital.

Utilizing the principals of “Float,” “Many,” and “Clubs” a complete business model can be expounded that contains very high aggregate revenue and cash flow projections, thereby attaining an entrepreneurial score in the 25 to 30 range, which is moderate, to a 35 to 40 range which is high. The highest possible entrepreneurial score is, of course, 3×3×3=27+8+10=45. As a general rule, entrepreneurs would like to begin with a score of 45, but that happy event is extremely rare. A company with a score of 45 may raise no venture capital while achieving a valuation of more than $1 billion on less than 10 years.

There are several laws of entrepreneurship, which can be followed in implementing a new business. The First Law of Entrepreneurship is based on the following formulation: V=P×S×E. The law of V=P×S×E defines the components of valuation. The First Law of Entrepreneurship states that if one selects companies with high quantitative values for the components, P, S, and E, he or she will achieve high valuations and create wealth. The variable P represents the size of the problem that the entrepreneurial team has identified. The variable S represents the elegance of the solution. The variable E represents the experience of the entrepreneurial team, and the variable V represents valuation. The most important of the three components is P, because if there is no problem then a good solution conveyed by an outstanding entrepreneurial team, will not generate revenues.

Examples of non-P industries in the late 1990's have included advertising-based “Dot.com” companies, tier one fiber optic telecommunications owners, electric cars, and a variety of food products that appear on supermarket shelves one month only to vanish the next. There are mathematical models for identifying big-P business models. And if one continually attempts to diligently place venture capital into big-P opportunities, the amount of capital wasted because the P is low rather than high will become less.

The Second Law of Entrepreneurship can be referred to generally as the “Law of the Big P.” With the billions of dollars poured into proposed solutions for society's major killers, such as cancer, heart disease, diabetes and alcoholism, and with the very high “V's. Accorded these companies, sometimes even before they have been approved by regulatory authorities, it can be hypothesized that V=fP. V is a function of P, or high valuations are accorded to entrepreneurial companies that seek to solve big problems. Numerous bio-tech start-ups have raised a large amount of venture capital with not much more than proposed elegant solutions, which are early results of the effect on malignancies and other body part destroyers of new re-combinations of cells and carriers, and entrepreneurial teams composed of earnest scientists and managers of the bio-tech start-ups deliver the solutions to those with the problem in a highly efficient manner, and pay back their founders, employees and venture capitalists with billions of dollars of returns.

The Third Law of Entrepreneurship can be referred to as the “Law of Risk Aversion.” There are typically five risks in a start-up or early stage company. There are 1,300 venture capital funds in the United States and an average of $20 million in cash in 1,100 of them and $200 million in 200 of them. It is the practice of the venture capitalist to accept no more than two of these risks, and the two that the venture capitalist can control most effectively are numbers three and four: marketing and management. The five risks are summarized in Table 2 below.

TABLE 2
Five Risks of a Start-Up Company

| Risk | Question |
|---|---|
| Development Risk | Can we develop the product? |
| Manufacturing Risk | If we can develop it, can we produce it? |
| Marketing Risk | If we can make it, can we sell it? |
| Management Risk | I few can sell it, can we sell it at a profit? |
| Growth Risk | If we can manage the company, can we grow it? |

Acceptable risks include marketing and management because they are the most controllable. Development and manufacturing/production risks are typically borne by the entrepreneur prior to his or her seeking venture capital, but can continue to exist throughout development of the business venture in the form of intellectual property issues (e.g., barriers to entry). The growth risk is typically borne by public investors after the venture capitalist has liquefied some or all of its investment. To remain an investor in a company after one has nursed it through its start-up, first stage, second stage, and initial public offering is to assume the noncontrollable risk of the company's stock price declining and giving back much of the hard-earned profit.

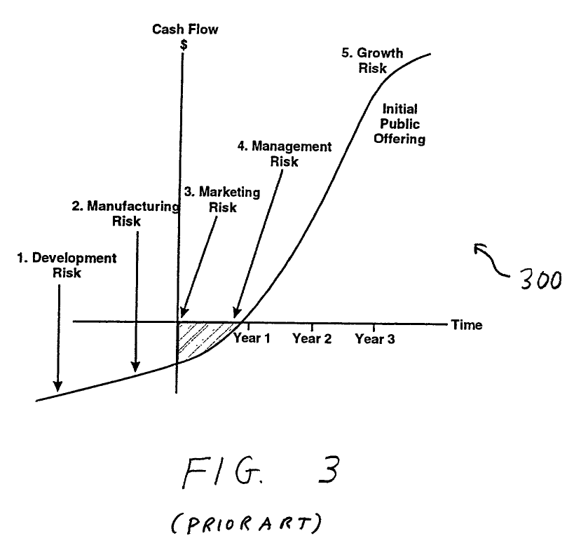

Venture capital investments are sold when a reasonable return has been achieved and the venture capitalist holds marketable securities. Entrepreneurial teams lighten up their holdings as well, to the degree permitted by the Securities Exchange Commission. To better understand the five risks in a start-up or early stage company, refer to FIG. 3, in which a prior art graph 300 illustrates the five stages of a start-up company.

It is the function of the venture capitalist to provide capital and management assistance to the start-up company after the product development and manufacturing risks have been eliminated. In the absence of venture capital approval, entrepreneurs can access angel capital, state grants or a variety of forms of “float”. The entrepreneur normally assumes the development risk when he or she identifies a large problem in need of a solution. If venture capitalists could conceive of solutions to large problems, they would be entrepreneurs (or their equivalents; i.e., artists, writers, scientists) rather than venture capitalists. There have been venture capitalists that funded on a regular basis the development stage, but they are no longer playing the game.

One or more of the following providers of capital typically assumes the development risk:

1. Wealthy individuals who hire tax attorneys to structure their investments in a manner that generates a reduction or elimination of their income taxes.

2. State and federal governments via grant programs the intent of which is job creation.

3. Strategic partners, such as large corporations, who invest at this stage in consideration for an ownership position plus the rights to market the product when it is developed.

4. Suppliers who see a large market for certain of their products if the products are successfully developed.

5. Family and friends who, because of emotional ties, are willing to invest in the entrepreneur's dream.

Rarely is it appropriate for venture capitalist to invest in a company prior to the development of a new product or service. However, every rule has its exceptions. A development risk may be assumed with not more than 5 percent of a venture capital fund's assets in the very earliest years of its life, and then only with a corporate customer or supplier as an investing partner. The reason for corporate co-investors is that the product, if developed, will have to be manufactured. The co-investing corporate partners are most likely to know how to produce the product, once developed. For example, Chester Carlson, the inventor of xerography, was funded by the Haloid Corp., which engaged Battelle Memorial Laboratories to develop the xerography process, which Xerox Corporation (nee Haloid) then produced.

The manufacturing or production risk is also inappropriate for venture capital. What if the solution to a large problem cannot be produced at a price low enough to make it more attractive than (a) continuing to live with the problem, or (b) competitive solutions? What can the venture capitalists do to lower the production costs? The answer is that there is not much that venture capitalists can realistically do to lower the production costs in such a scenario. Likewise, what if the solution can be manufactured at a low enough cost to attract customers, but it is missing a critical component that resists all attempts to produce it? What can the venture capitalist do to produce it? Again, there is not much that the venture capitalist can do to produce it.

Venture capitalists usually do not seek companies that are unable to demonstrate a completely operative product or service. Clearly, the product or service can be in prototype form, and it frequently is. But, can it be demonstrated, tested, and placed at the site of a potential customer, then the venture capitalist will ask this beta site customer: “Did it solve your problem? Would you purchase it? How much would you pay for it?”

There are exceptions to averting the manufacturing risk, which are similar to those for averting the development risk. If the venture capital fund is in its formative years and if a co-investor exists that is able to manufacture the product, then a small amount of the venture capital fund may be used to invest in companies at this stage of their development. The product, of course, must be absolutely proprietary, protected by a bulletproof patent filed in the key countries, in order to make adding a third risk acceptable.

Other examples of “elegance” are evidence in service companies. In service companies, where patents are not germane, the delivery system must be very difficult to duplicate in a short period of time and heavily underrated by existing competition using other delivery systems. For example, Federal Express Corp. introduced a new means of delivering small packages overnight. Among its more unique features was that it “absolutely, positively” guaranteed next-day delivery. The competition relied on commercial airlines to deliver their small freight. Before Federal Express could attract venture capital it hired two management-consulting firms to measure the demand for the service, the size of the demand and price elasticity, the key cities to begin in and every other factor they could think of. In this manner, the production risk was investigated and $96 million of venture capital was raised.

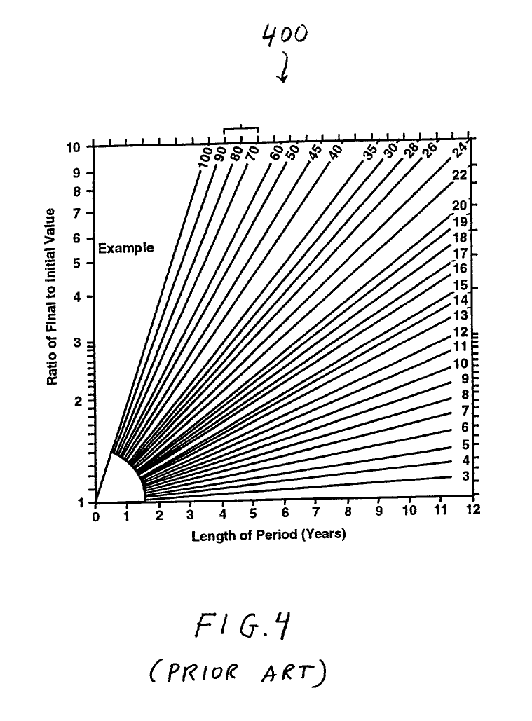

As for the growth risk, one could argue that venture capitalists are equipped, perhaps more so, than anyone to measure and deal with this particular risk, since they know the company from its infancy and are familiar with its products, markets, and management team. The other side of the coin is that the investors who hire the venture capitalists do not engage their services to invest in publicly held companies; rather, it is their task to distribute to their investors the shares of publicly-held companies, which the investors can determine to hold or sell as they choose. It would seem that the more reasonable approach is to sell the companies once they are public or distribute their shares to the fund's investors to hold or sell. The overriding issue is how long can a company continue to grow at a rate acceptable to a venture capitalist? The target rate of return of most venture capital funds is approximately five times in three years or 10 times in five years, which works out to a compound return on investment of approximately 70-90 percent per annum as depicted in graph 400 of FIG. 4.

Achieving an 80-90 percent compound annual return over three years or over five years is quite an accomplishment. To maintain it beyond that requires the continual introduction of products and services that solve a continual group of problems for a large number of people. Very few companies can develop a succession of managers who are capable of maintaining near-miraculous growth records. Intel comes the closest to achieving that kind of performance, and it is often hailed as the only mega billion-dollar entrepreneurial company in the United States. The exception proves the rule. The entrepreneurial period in a person's life is a stage of development lasting about five years, after which, if one succeeds, he or she enters a time period of being an asset manager. In this period, he or she is more cautious because there are assets to protect. The same is true of companies. When they mature from an entrepreneurial to a managed stage, their growth slows down because they are more cautious. There are assets to protect. This is the primary reason that companies in this stage address a certain kind of risk better understood by public investors than by venture capital investors.

Thus, venture capitalists accept only two of the five risks addressed by start-up and early stage companies: the marketing and the management risk. Three other risks—development, production, and growth—are best understood by other kinds of investors. By minimizing the number and kind of risks that they are willing to accept, venture capitalists are risk averters rather than risk takers. Although this may make the breed less attractive to the financial press who would prefer to think of them as “gunslingers,” it is axiomatic. The most successful venture capitalists understand when to get into and when to get out of deals; that is which risks to accept and which ones to avoid.

As explained previously, the method and system of the present invention sets forth a variety of DEJ factors that can enable a would-be entrepreneur or investor to determine which if any, insights into entrepreneurial opportunities, he or she should pursue and which ones should be ignored. The DEJ factors described herein are good indicators that can assist an entrepreneur and/or investor in determining which entrepreneurial opportunities to seize and which ones to pass over.

A potential entrepreneur can thus predict his or her eventual success or failure by counting the number of DEJ (Demonstrable Economic Justifications) factors in his or her business idea. Here are the eight DEJ factors, which were explained previously and will be examined further in greater detail:

1. Existence of a large number of receivers

2. Homogeneity of receivers

3. Existence of qualified receivers

4. Existence of competent providers

5. Absence/Existence of institutional barriers to entry

6. “Hey, it really works!” factor

7. Invisibility

8. Optimum price-cost relationship

The beauty of the DEJ-factor system is its absolute infallibility: if the entrepreneurial idea is assessed carefully and the existing DEJ factors honestly counted, the prediction of future success will be surprisingly accurate. The more DEJ factors that can be counted, the more successful the company will be. A variety of terms can be utilized to refer to companies rated by the DEJ-factor system. For example, a new company can be referred to as a “super DEJ company” if it possesses all eight DEJ factors. A business may also be referred to as a “majority DEJ” if it has all but one of the DEJ factors. Additionally, a company can be referred to as a “marginal DEJ company” if it possesses only six of the eight DEJ factors. Finally, an enterprise may be considered a “low DEJ company” if it possesses five or fewer DEJ factors.

If the proposed business idea possesses all eight DEJ factors, such a company should be pursued immediately because it comprises a super DEJ company and, as such, it is certain to solve a problem for a large number of people and make its founders and investors very wealthy. Another virtue of the super DEJ company, is that it does not require a great deal of venture capital. This sort of enterprise addresses a problem so large, and provides a solution—or a delivery system—so unique that it can be launched largely with customer financing. Because the ownership and the profits will only have to be shared with a few angel capitalists, the founders of such a company can expect to become wealthy in three to five years.

If the proposed entrepreneurial idea has seven of the eight DEJ factors, such a business venture should also be vigorously pursued. Because it is a majority DEJ idea, it has a very high probability of success. Such a company will require, however, a considerable amount of venture capital, perhaps 10 times more than a super DEJ company would need. The rate of return on a majority DEJ company will be lower than that of a super DEJ business, and this applies not only to the return on capital but to the return on the time and labor as well.

An entrepreneurial opportunity that possesses six of the eight DEJ factors is likely to be only marginally successful. The founders of such a company should consider it very carefully before launching it because it may require two three times more venture capital than a majority DEJ company without offering the high probability of success.

If five or fewer DEJ factors are counted, the would-be entrepreneur should consider forgetting his or new business idea. Such an enterprise will likely require an impossibly large amount of capital and would have little chance of success. By launching a low DEJ company, the entrepreneur would be certain to waste his or her time and the investors' capital.

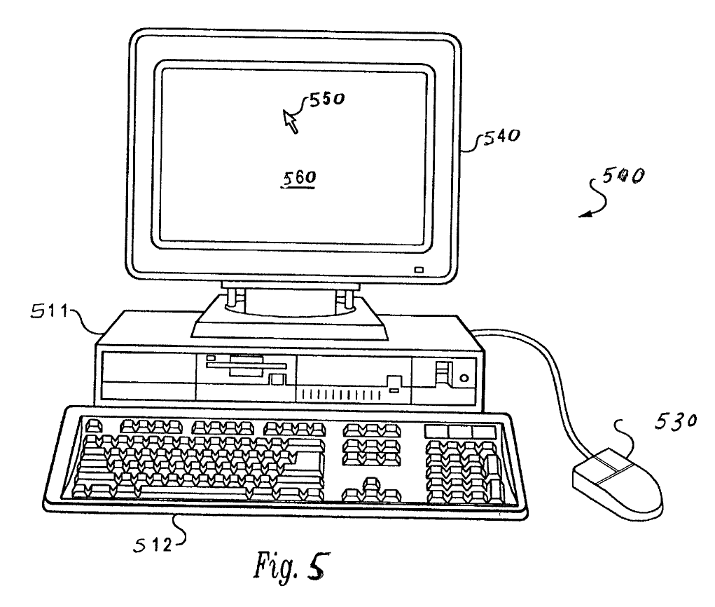

FIG. 5 is a pictorial diagram of a data-processing system 500 in which a preferred embodiment of the present invention may be implemented. Data-processing system 500 can be, for example, a personal computer or a computer workstation. The present invention may be implemented on a variety of computers under a number of different operating systems. Data-processing system 500 can also be implemented as a mainframe computer. Data-processing system 500 may be, for example, a stand-alone system or part of a network such as a local area network (LAN) or a wide area network (WAN).

Referring now to the drawings and in particular to FIG. 5, there is depicted a diagram of a data-processing system 500 which may be utilized by a preferred embodiment of the present invention. Data-processing system 500 comprises processor unit 511, keyboard 512, mouse 530, and graphic display (or monitor) 540. Keyboard 512, and mouse 530 constitute user input devices, and graphic display 540 constitutes an output device. Mouse 530 is utilized to control cursor 550 displayed on screen 560 of graphic display 540. Data-processing system 500 supports a Graphic User Interface (GUI) which allows a user to “point-and-shoot” by moving cursor 550 to an icon or specific location on screen 560 via mouse 530 and then press one of the buttons on mouse 530 to perform a user command.

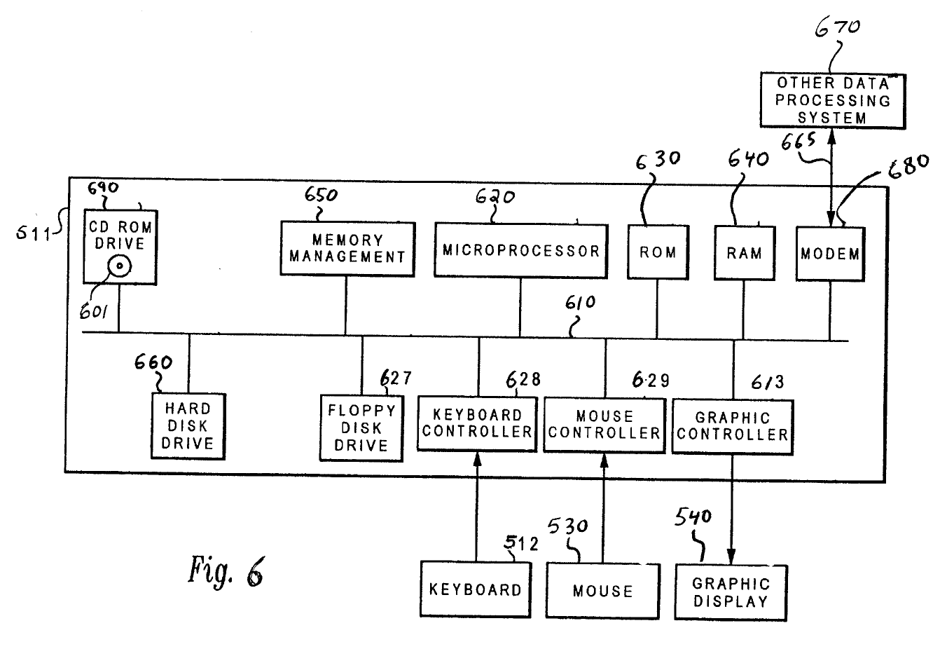

Referring now to FIG. 6, there is illustrated a block diagram of the components for data-processing system 500 of FIG. 5. Unit 511 includes system bus 610 to which various components are attached and by which communications among various components is accomplished. Microprocessor 620, connecting to system bus 610, is supported by read only memory (ROM) 630 and random access memory (RAM) 640, both of which are also connected to system bus 610. Note that in FIGS. 5 and 6, like or analogous parts are indicated by identical reference numerals. Thus, unit 511 is illustrated in both FIGS. 5 and 6.

ROM 630 contains, among other codes, the Basic Input/Output System (BIOS), which controls certain basic hardware operations, such as interactions of hard disk drive 660 and floppy disk drive 627. RAM 640 is the main memory within which the operating system and application programs having the present invention incorporated are loaded. A memory management device 650 is connected to system bus 610 for controlling all Direct Memory Access (DMA) operations such as paging data between RAM 640 and hard disk drive 660 or floppy disk drive 627.

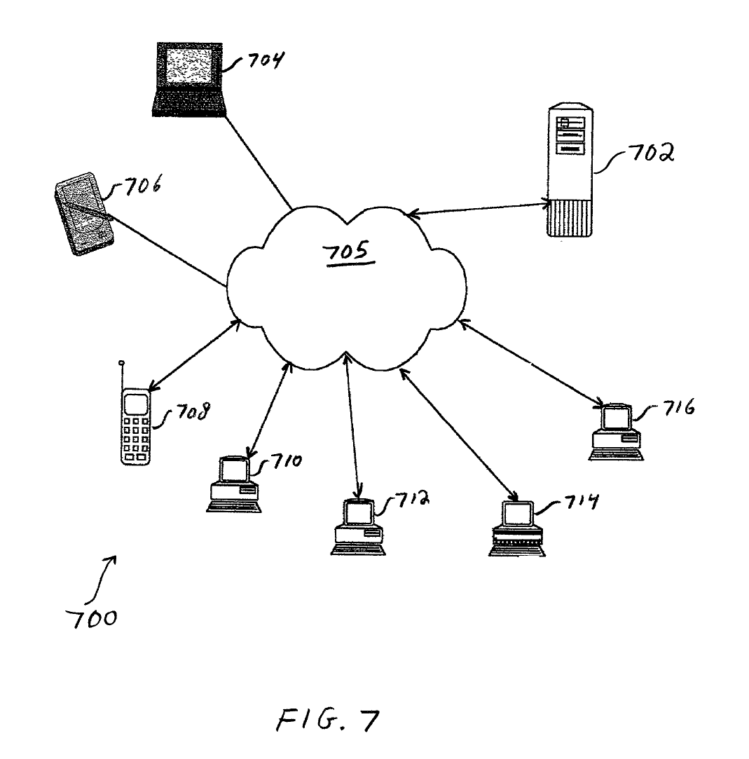

As shown in FIG. 6, a CD ROM drive 690 having a compact disk 601 inserted inside is installed within processor unit 511. However, several other peripherals, such as optical storage media, printers, etc., may also be added to data-processing system 500. Further, a modem 680 may be utilized to communicate with other data processing systems 670 across communications line 665. It should be appreciated by those skilled in the art that modem 680 can be provided in the form of wireless communication equipment used to communicate to public networks (e.g., CDMA) or local wireless local area networks (e.g., WLANs) using Bluetooth and the 802.X family of wireless communication protocols. It should also be appreciated that processing unit 511 can be provided in the form of a wireless, handheld unit such as a personal digital assistant, laptop or smartphone in communication with a wireless network (as explained and further illustrated in FIG. 7)

Processor unit 511 further comprises three input/output (I/O) controllers, namely, keyboard controller 628, mouse controller 629 and graphic controller 613, all of which are connected system bus 610. Keyboard controller 628 provides the hardware interface for keyboard 512. Mouse controller 629 provides the hardware interface for mouse 530, and graphic controller 613 provides the hardware interface for graphic display 540. The hardware setup illustrated in FIGS. 5 and 6 is typical but may vary for a specific application.

It can be appreciated by those skilled in the art that the present invention may be implemented as a self-consistent sequence of steps leading to a desired result. The steps are those requiring the physical manipulation of physical quantities. Usually, although not necessarily, these quantities take the form of electrical or magnetic signals capable of being stored, transferred, combined, compared, and otherwise manipulated.

It has proven convenient at times by those skilled in the art, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Further, the manipulations performed are often referred to in terms, which are commonly associated with mental operations performed by a human operator. No such capability of a human operator is necessary or desirable in most cases of the operations described herein, which form part of the present invention. As indicated herein, these operations are primarily machine operations. Useful machines for performing operations of a preferred embodiment of the present invention include data-processing systems, such as a general-purpose digital computer or other similar devices. In all cases the distinction between the method of operations in operating a computer and the method of computation itself should be borne in mind.

The present invention relates to method steps for processing electrical or other (e.g. mechanical, chemical) physical signals to generate other desired physical signals, and can be implemented via a computer or microcomputer. It can be appreciated by those skilled in the art that the methods described herein can be implemented as a program product (e.g., a control program residing in a computer memory) containing instructions that when executed on a CPU, carry out the operations depicted in the logic flow diagrams herein. While the present invention is described in the context of a fully functional computer system, those skilled in the art will further appreciate that the present invention is capable of being distributed as a program product in a variety of forms, and that the present invention applies equally, regardless of the particular type of signal-bearing media utilized to actually carry out the distribution. Examples of signal-bearing media include recordable-type media, such as floppy disks, hard-disk drives and CD ROM's, and transmission-type media, such as digital and analog communication links. Such a program product may be processed via a processor such as microprocessor 620, which is illustrated in FIG. 6 herein.

Preferred implementations of the invention can include implementations to execute the method or methods described herein as a program product residing in a memory of microcomputer. The program product thus includes sets of instructions for executing the method and system described herein. Until required by a microcomputer, the set of instructions may be stored as a computer-program product in another computer memory. For example, the set of instructions may be stored as a computer-program product in a disk drive attached to a microcomputer (which may include a removable memory such as an optical disk or floppy disk for eventual use in the disk drive).

The computer-program product can also be stored at another computer and transmitted, when desired, to a user's workstation by an internal or external network. Those skilled in the art will appreciate that the physical storage of the sets of instructions physically changes the medium upon which it is stored so that the medium carries computer-readable information. The change may be electrical, magnetic, chemical, or some other physical change. While it is convenient to describe the invention in terms of instructions, symbols, characters, or the like, the reader should remember that all of these and similar terms should be associated with the appropriate physical elements.

FIG. 7 illustrates a client-server and network-based system 700 in which an embodiment of the present invention may be implemented. Thus, in one embodiment, shown in FIG. 7, the present invention may be performed through the implementation of a client-server based system 700 over globally connected data networks, such as the Internet, wireless provider networks, and local area networks (wired and wireless). A server 702 can communicate with each individual client 704, 706, 708, 710, 712, 714, and 716 via the Internet 705. Server 702 contains website information including web pages written in HTML, ASP, XML, Perl, JavaScript, and the like, as well as application programs and databases to perform the invention. Clients 704, 706, 708, 710, 712, 714, and 716 interact with the website over Internet 705 to receive and transmit information between the client and the server. Clients 704, 706, 708, 710, 712, 714, and 716 can be any type of computer or smart device with the capability to connect to the Internet. These devices include, but are not limited to, desktop computers, laptop or notebook computers, cellar phones, smart phones, PCS phones, personal digital assistants (PDA's), two-way pagers, and the like. Note that the term “Internet” is well known in the art and thus a detailed explanation of the Internet is not necessary. Internet 705, however, can be implemented in the context of other types of communication networks, including wireless telecommunications networks.

The present invention may be implemented as a program product (i.e., computer program product) composed of one or more modules. The term “module” as utilized herein thus generally refers to a software module. In the computer programming arts, a module can be implemented as a collection of routines and data structures that performs particular tasks or implements a particular abstract data type. Modules generally are composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based. Thus, when referring to a “module” herein, the present inventors are referring so such software modules or implementations thereof. It can be appreciated by those skilled in the art the methodology illustrated in FIGS. 1 and 2, for example, can be implemented as a series of modules. Such modules can be utilized separately or together to form a program product that can be implemented through signal-bearing media, including transmission media and recordable media. The present invention can thus be implemented as a program product composed of a plurality of such modules, which can be interactively displayed for a user on a display screen of a data-processing system (e.g., computer). Such interactivity may be provided by a graphical user interface (GUI), which is well known in the art, including Internet browser applications thereof.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows.

Having thus described the invention what is claimed is:

1. A method for evaluating the probability of success or failure of an entrepreneurial endeavor, said method comprising the steps of:
designating a plurality of entrepreneurial issues associated with said entrepreneurial endeavor;
assigning a value from among a plurality of values to each entrepreneurial issue among said plurality of entrepreneurial issues;
compiling a score based on a summation of a plurality of values respectively assigned to said plurality of entrepreneurial issues, wherein said score is indicative of the probability of success or failure of said entrepreneurial endeavor.

2. The method of claim 1 wherein said plurality of entrepreneurial issues include factors represented by variables P, S and E, wherein S represents an elegance of an entrepreneurial solution to said problem, and E represents an experience of an associated entrepreneurial team.

3. The method of claim 2 further comprising the step of:
determining a valuation of said entrepreneurial endeavor based on a formulation V=P×S×E, wherein V represents said valuation, S represents said elegance of said entrepreneurial solution to said problem, and E represents said experience of said associated entrepreneurial team.

4. The method of claim 3 wherein the step of assigning a value from among a plurality of values to each entrepreneurial issue among said plurality of entrepreneurial issues, further comprises the step of:
assigning said value to P, wherein said value comprises a number 1, a number 2 or a number 3, such that said number 3 is associated with a large-sized entrepreneurial problem, said number 2 is associated with a medium-sized entrepreneurial problem and said number 1 is associated with a small-sized entrepreneurial problem.

5. The method of claim 3 wherein the step of assigning a value from among a plurality of values to each entrepreneurial issue among said plurality of entrepreneurial issues, further comprises the step of:
assigning said value to S, wherein said value comprises a number 1, a number 2 or a number 3, wherein number 1 is associated with a first-to-market entrepreneurial solution, said number 2 is associated with a first-to-market and a difficult-to-replicate entrepreneurial solution, and said number 3 is associated with a proprietary, a first-to-market, and a difficult-to-replicate entrepreneurial solution.

6. The method of claim 3 wherein the step of assigning a value from among a plurality of values to each entrepreneurial issue among said plurality of entrepreneurial issues, further comprises the step of, further comprises the step of:
assigning said value to E, wherein said value comprises a number 1, a number 2, or a number 3, wherein said number 1 is associated with an entrepreneurial team that does not possess any prior entrepreneurial launch experience, said number 2 is associated with an entrepreneurial team possessing at least one individual who has launched and operated an entrepreneurial effort previously, and said number 3 is associated with an entrepreneurial team that has previously managed an entrepreneurial launch.

7. The method of claim 1 wherein said plurality of entrepreneurial issues includes a plurality of DEJ factors.

8. The method of claim 7 wherein the step of assigning a value from among a plurality of values to each entrepreneurial issue among said plurality of entrepreneurial issues, further comprises the step of:
assigning a value from among said plurality of values to each DEJ factor among said plurality of DEJ factors.

9. The method of claim 1 wherein said plurality of entrepreneurial issues include factors represented by variables F, M, and C, wherein F represents a Float factor, M represents a Many factor, and C represents a Clubs factor.

10. A method for evaluating the probability of success or failure of an entrepreneurial endeavor, said method comprising the steps of:
designating a plurality of entrepreneurial issues associated with said entrepreneurial endeavor, wherein said plurality of entrepreneurial issues includes:
a plurality of factors represented by variables P, S and E, wherein P represents a size of a problem, S represents an elegance of an entrepreneurial solution to said problem and E represents an experience of an associated entrepreneurial team;
a plurality of factors that include a plurality of DEJ factors; and
a plurality of factors represented by variables F, M, and C, wherein F represents a Float factor, M represents a Many factor, and C represents a Clubs factor;
assigning a value from among a plurality of values to each entrepreneurial issue among said plurality of entrepreneurial issues;
determining a valuation of said entrepreneurial endeavor based on a formulation V=P×S×E, wherein P represents said size of said problem, V represents said valuation, S represents said elegance of said entrepreneurial solution to said problem, and E represents said experience of said associated entrepreneurial team; and
compiling a score based on a summation of a plurality of values respectively assigned to said plurality of entrepreneurial issues, wherein said score is indicative of the probability of success or failure of said entrepreneurial endeavor.

11. A system for evaluating the probability of success or failure of an entrepreneurial endeavor, said system comprising:
module for designating a plurality of entrepreneurial issues associated with said entrepreneurial endeavor;
module for assigning a value from among a plurality of values to each entrepreneurial issue among said plurality of entrepreneurial issues;
module for compiling a score based on a summation of a plurality of values respectively assigned to said plurality of entrepreneurial issues, wherein said score is indicative of the probability of success or failure of said entrepreneurial endeavor.

12. The system of claim 11 wherein said plurality of entrepreneurial issues include factors represented by variables P, S and E, wherein P represents a size of a problem, S represents an elegance of an entrepreneurial solution to said problem and E represents an experience of an associated entrepreneurial team.

13. The system of claim 12 further comprising:
module for determining a valuation of said entrepreneurial endeavor based on a formulation V=P×S×E, wherein V represents said valuation, P represents said size of said problem, S represents said elegance of said entrepreneurial solution to said problem, and E represents said experience of said associated entrepreneurial team.

14. The system of claim 13 further comprising:
module for assigning said value to P, wherein said value comprises a number 1, a number 2 or a number 3, such that said number 3 is associated with a large-sized entrepreneurial problem, said number 2 is associated with a medium-sized entrepreneurial problem and said number 1 is associated with a small-sized entrepreneurial problem.

15. The system of claim 13 further comprising
module for assigning said value to S, wherein said value comprises a number 1, a number 2 or a number 3, wherein number 1 is associated with a first-to-market entrepreneurial solution, said number 2 is associated with a first-to-market and a difficult-to-replicate entrepreneurial solution, and said number 3 is associated with a proprietary, a first-to-market, and a difficult-to-replicate entrepreneurial solution.

16. The system of claim 13 further comprising:
module for assigning said value to E, wherein said value comprises a number 1, a number 2, or a number 3, wherein said number 1 is associated with an entrepreneurial team that does not possess any prior entrepreneurial launch experience, said number 2 is associated with an entrepreneurial team possessing at least one individual who has launched and operated an entrepreneurial effort previously, and said number 3 is associated with an entrepreneurial team that has previously managed an entrepreneurial launch.

17. The system of claim 11 wherein said plurality of entrepreneurial issues includes a plurality of DEJ factors.

18. The system of claim 17 further comprising
module for assigning a value from among said plurality of values to each DEJ factor among said plurality of DEJ factors.

19. The system of claim 11 wherein said plurality of entrepreneurial issues include factors represented by variables F, M, and C, wherein F represents a Float factor, M represents a Many factor, and C represents a Clubs factor.

20. A system for evaluating the probability of success or failure of an entrepreneurial endeavor, said system comprising:
module for designating a plurality of entrepreneurial issues associated with said entrepreneurial endeavor, wherein said plurality of entrepreneurial issues includes:
a plurality of factors represented by variables P, S and E, wherein P represents a size of a problem, S represents an elegance of an entrepreneurial solution to said problem, and E represents an experience of an associated entrepreneurial team;
a plurality of factors that include a plurality of DEJ factors; and
a plurality of factors represented by variables F, M, and C, wherein F represents a Float factor, M represents a Many factor, and C represents a Clubs factor;
module for assigning a value from among a plurality of values to each entrepreneurial issue among said plurality of entrepreneurial issues;
module for determining a valuation of said entrepreneurial endeavor based on a formulation V=P×S×E, wherein V represents said valuation, P represents said size of said problem, S represents said elegance of said entrepreneurial solution to said problem and E represents said experience of said associated entrepreneurial team; and
compiling a score based on a summation of a plurality of values respectively assigned to said plurality of entrepreneurial issues, wherein said score is indicative of the probability of success or failure of said entrepreneurial endeavor.

21. A computer program product for evaluating the probability of success or failure of an entrepreneurial endeavor, wherein said computer program product resides in a computer memory of a data-processing system, said computer program product comprising:
module for designating a plurality of entrepreneurial issues associated with said entrepreneurial endeavor;
module for assigning a value from among a plurality of values to each entrepreneurial issue among said plurality of entrepreneurial issues;
module for compiling a score based on a summation of a plurality of values respectively assigned to said plurality of entrepreneurial issues, wherein said score is indicative of the probability of success or failure of said entrepreneurial endeavor.

22. The computer program product of claim 21 wherein said plurality of entrepreneurial issues include factors represented by variables P, S and E, wherein P represents a size of a problem, S represents an elegance of an entrepreneurial solution to said problem, and E represents an experience of an associated entrepreneurial team.

23. The computer program product of claim 22 further comprising:
module for determining a valuation of said entrepreneurial endeavor based on a formulation V=P×S×E, wherein V represents said valuation, P represents said size of said problem, S represents said elegance of said entrepreneurial solution to said problem, and E represents said experience of said associated entrepreneurial team.

24. The computer program product of claim 23 further comprising:
module for assigning said value to P, wherein said value comprises a number 1, a number 2 or a number 3, such that said number 3 is associated with a large-sized entrepreneurial problem, said number 2 is associated with a medium-sized entrepreneurial problem and said number 1 is associated with a small-sized entrepreneurial problem.

25. The computer program product of claim 23 further comprising
module for assigning said value to S, wherein said value comprises a number 1, a number 2 or a number 3, wherein number 1 is associated with a first-to-market entrepreneurial solution, said number 2 is associated with a first-to-market and a difficult-to-replicate entrepreneurial solution, and said number 3 is associated with a proprietary, a first-to-market, and a difficult-to-replicate entrepreneurial solution.

26. The computer program product of claim 23 further comprising:
module for assigning said value to E, wherein said value comprises a number 1, a number 2, or a number 3, wherein said number 1 is associated with an entrepreneurial team that does not possess any prior entrepreneurial launch experience, said number 2 is associated with an entrepreneurial team possessing at least one individual who has launched and operated an entrepreneurial effort previously, and said number 3 is associated with an entrepreneurial team that has previously managed an entrepreneurial launch.

27. The computer program product of claim 21 wherein said plurality of entrepreneurial issues includes a plurality of DEJ factors.

28. The computer program product of claim 27 further comprising
module for assigning a value from among said plurality of values to each DEJ factor among said plurality of DEJ factors.

29. The computer program product of claim 21 wherein said plurality of entrepreneurial issues include factors represented by variables F, M, and C, wherein F represents a Float factor, M represents a Many factor, and C represents a Clubs factor.

30. A computer program product for evaluating the probability of success or failure of an entrepreneurial endeavor, wherein said computer program product resides in a computer memory of a data-processing system, said computer program product comprising:
module for designating a plurality of entrepreneurial issues associated with said entrepreneurial endeavor, wherein said plurality of entrepreneurial issues includes:
a plurality factors represented by variables P, S and E, wherein P represents a size of a problem, S represents an elegance of an entrepreneurial solution to said problem, and E represents an experience of an associated entrepreneurial team;
a plurality of factors that include a plurality of DEJ factors; and
a plurality of factors represented by variables F, M, and C, wherein F represents a Float factor, M represents a Many factor, and C represents a Clubs factor;
module for assigning a value from among a plurality of values to each entrepreneurial issue among said plurality of entrepreneurial issues;
module for determining a valuation of said entrepreneurial endeavor based on a formulation V=P×S×E, wherein V represents said valuation, P represents said size of said problem, S represents said elegance of said entrepreneurial solution to said problem, and E represents said experience of said associated entrepreneurial team; and
compiling a score based on a summation of a plurality of values respectively assigned to said plurality of entrepreneurial issues, wherein said score is indicative of the probability of success or failure of said entrepreneurial endeavor.
